(19) United States
(12) Patent Application Publication
(10) Pub. No.: US 2026/0139721 A1
(43) Pub. Date: May 21, 2026

(54) NEGATIVE AIR SPRING VOLUME SEALHEAD FOR AIR-SPRING ASSEMBLY

(71) Applicant: Fox Factory, Inc., Duluth, GA (US)

(72) Inventors: William M. Becker, Aptos, CA (US); Damon Gilbert, Aptos, CA (US)

(21) Appl. No.: 19/227,929

(22) Filed: Jun. 4, 2025

Related U.S. Application Data
(60) Provisional application No. 63/720,875, filed on Nov. 15, 2024.

(51) Int. Cl. F16F 9/02; B62K 25/06; F16F 9/36

(52) U.S. Cl. CPC F16F 9/0227; B62K 25/06; F16F 9/362; F16F 2230/007; F16F 2230/30

(57) ABSTRACT

A suspension fork includes a lower tube, an upper tube telescopically engaged with the lower tube, and an air-spring assembly disposed within the lower tube and the upper tube. The air-spring assembly includes a positive air chamber, a negative air chamber, a piston dividing the positive air chamber and the negative air chamber, and a sealhead positioned proximate the negative air chamber. The sealhead includes an outer wall and an inner wall defining an aperture in which a shaft coupled to the piston is movably received. A hollow chamber is positioned between the outer wall and inner wall. A topout plate comprising a plurality of openings in communication with the hollow chamber is attached to the sealhead. The hollow chamber of the sealhead increases a volume of the negative air chamber, providing improved suspension performance.

### CROSS-REFERENCE TO RELATED APPLICATION

This application claims the benefit of and priority to U.S. Provisional Ser. No. 63/720,875 filed Nov. 15, 2024, entitled “Inverted Suspension Fork with Improved Air Spring and Lubrication,” the contents of which being incorporated by reference in their entirety herein.

### TECHNICAL FIELD

The present disclosure generally relates to suspension forks for vehicles and, in particular, to suspension forks with improved air spring systems

### BACKGROUND

Suspension forks are widely used in various vehicles, particularly bicycles and motorcycles, to absorb shocks and vibrations, providing a smoother ride for the rider. These forks typically consist of two telescoping tubes that compress and extend as the vehicle encounters bumps or uneven terrain. Some modern suspension forks utilize air-spring systems to provide adjustable suspension characteristics.

In an air-spring system of a suspension fork, there are two air chambers, namely, a positive air chamber and a negative air chamber separated by an air piston, where the air piston is attached to a shaft. When the fork is fully extended, the positive air chamber is relatively large, while the negative air chamber is comparatively small. As the fork compresses during use, the piston moves into the positive air chamber, compressing the air within. This compression creates an increasing positive air spring curve that supports the weight of the vehicle and helps absorb impacts from bumps and other obstacles encountered during riding.

### BRIEF SUMMARY

According to an aspect of the present disclosure, a suspension fork is provided. The suspension fork includes a first tube and a second tube telescopically engaged with the first tube. An air-spring assembly is disposed within at least one of the first tube or the second tube. The air-spring assembly includes a positive air chamber and a negative air chamber, a piston dividing the positive air chamber and the negative air chamber, the piston coupled to and driven by a shaft, and a sealhead assembly positioned proximate the negative air chamber. The sealhead assembly includes a sealhead body comprising an outer wall and an inner wall, the inner wall defining an aperture in which the shaft is movably received, a hollow chamber positioned between the outer wall and the inner wall, and a topout plate comprising at least one opening in communication with the hollow chamber.

The topout plate may be coupled to the sealhead body. The suspension fork may further comprise a topout bumper configured to contact at least a portion of the sealhead assembly. The at least one opening may be positioned radially outward from the aperture defined by the inner wall. The outer wall and the inner wall may further comprise plate stopping surfaces. The hollow chamber of the sealhead assembly may increase a volume of the negative air chamber. The sealhead body may comprise a base portion and an extended portion extending from the base portion, the base portion having a diameter greater than the extended portion, wherein the aperture extends through the base portion and the extended portion.

According to another aspect of the present disclosure, an air-spring assembly configured to be disposed within at least one of a lower tube or an upper tube of a suspension fork is provided. The air-spring assembly includes a shaft comprising a first end and a second end opposite the first end, a piston attached to the shaft at a first end, and a topout bumper attached along the shaft, the piston configured to translate within a cylinder defined by the at least one of the lower tube or the upper tube, the piston defining a positive air chamber and a negative air chamber.

The air-spring assembly also includes a sealhead assembly positioned proximate the negative air chamber. The sealhead assembly includes a sealhead body comprising an outer wall and an inner wall, the inner wall defining an aperture in which the shaft is movably received, a chamber positioned between the outer wall and the inner wall in communication with the negative air chamber such that a volume of the negative air chamber is increased, and a topout plate comprising at least one opening in communication with the chamber.

The topout plate may be coupled to the sealhead body. The outer wall and the inner wall of the sealhead body may further comprise plate stopping surfaces. The topout bumper may be configured to contact at least a portion of the sealhead assembly. The suspension fork may be an inverted suspension fork. The sealhead assembly may further comprise an anti-click device positioned between the outer wall of the sealhead body and an inner wall of the cylinder. The at least one opening may be positioned radially outward from the aperture defined by the inner wall.

The sealhead body may comprise a base portion and an extended portion extending from the base portion, the base portion having a diameter greater than the extended portion, wherein the aperture extends through the base portion and the extended portion. The outer wall may comprise an outer wall surface configured to contact an inner surface of the cylinder, the outer wall surface comprising at least one external annular groove having at least one air seal positioned therein that prevents air to travel along the outer wall surface from the negative air chamber.

According to another aspect of the present disclosure, a sealhead assembly is provided. The sealhead assembly includes a sealhead body comprising an outer wall and an inner wall, the inner wall defining an aperture configured to receive an air piston shaft, a hollow chamber positioned between the outer wall and the inner wall, and a topout plate comprising at least one opening in communication with the hollow chamber.

According to other aspects of the present disclosure, the sealhead assembly may include one or more of the following features. The outer wall may comprise an outer wall surface configured to contact an inner surface of a suspension fork tube, the outer wall surface comprising at least one external annular groove having at least one air seal positioned therein that prevents air to travel along the outer wall surface from the negative air chamber. The topout plate may be coupled to the body portion, and the at least one opening may be positioned radially outward from the aperture. The sealhead assembly may further comprise a base portion and an extended portion extending from the base portion, the base portion having a diameter greater than the extended portion, wherein the aperture extends through the base portion and the extended portion.

This summary is provided to introduce a selection of concepts in a simplified form that are further described below in the detailed description. The summary is not intended to identify key features or essential features of the claimed subject matter, nor is it intended to be used as an aid in determining the scope of the claimed subject matter. The foregoing general description of the illustrative embodiments and the following detailed description thereof are merely exemplary aspects of the teachings of this disclosure and are not restrictive.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a front view of a suspension fork according to various embodiments of the present disclosure.

FIG. 2 is a front view of the suspension fork of FIG. 1 shown in full compression according to various embodiments of the present disclosure.

FIG. 3 is a front view of the suspension fork of FIG. 1 shown in full extension according to various embodiments of the present disclosure.

FIG. 4 is a cross-sectional view of the suspension fork of FIG. 1 showing an air-spring assembly according to various embodiments of the present disclosure.

FIG. 5 is a cross-sectional view of a portion of the air-spring assembly of FIG. 4 having a sealhead according to various embodiments of the present disclosure.

FIG. 6 is a cross-sectional view of the sealhead of FIG. 5 according to various embodiments of the present disclosure.

FIG. 7 is another cross-sectional view of a portion of the air-spring assembly of FIG. 4 having the sealhead of FIG. 6 according to various embodiments of the present disclosure.

### DETAILED DESCRIPTION

The present disclosure relates to a suspension fork having an air-spring assembly and, more specifically, relates to a negative air spring volume sealhead for use in an air-spring assembly of a suspension fork. Suspension forks may be utilized in various vehicles, such as bicycles and motorcycles, to absorb shocks and vibrations encountered during riding. These forks typically include two telescoping tubes that compress and extend as the vehicle traverses uneven terrain.

In some scenarios, the suspension fork may be an inverted design, referred to as an inverted suspension fork, where larger diameter upper tubes are fixed to the vehicle frame and the smaller diameter lower tubes slide within the upper tubes. Some suspension forks incorporate air-spring assemblies to provide adjustable suspension characteristics. In an air-spring assembly, two air chambers, a positive or main air chamber and a negative air chamber, are separated by an air piston operatively coupled to a shaft. Movement of the shaft causes the air piston to translate in a cylinder. As the suspension fork compresses during use, the piston may move into the positive air chamber, compressing the air within and creating a progressive spring rate. The negative air chamber may help reduce initial breakaway force and improve small bump sensitivity. The relative sizes and pressures of these air chambers may be adjustable to fine-tune performance of the suspension fork for different riding conditions and rider preferences.

For tuning purposes, it can be beneficial to have a relatively high negative volume airspace. Maximizing negative volume tends to produce an air-spring assembly with desirable suspension qualities. A larger negative volume airspace can provide several advantages for suspension performance. The larger negative volume airspace can help reduce initial breakaway force, improving small bump sensitivity and providing a smoother ride feel at the beginning of the suspension travel. Additionally, a higher negative volume can create a more linear spring rate throughout the travel range, which many riders find preferable for consistent performance across varied terrain. By carefully balancing the positive and negative air chambers, suspension designers can fine-tune behavior of a suspension fork to achieve optimal responsiveness and support for different riding styles and conditions.

Accordingly, various embodiments are described herein for a sealhead for use in a suspension fork that provides an improved air-spring assembly. A suspension fork can include telescopically engaged lower and upper tubes, with an air-spring assembly disposed within. The air-spring assembly includes positive and negative air chambers separated by a piston operatively coupled to a shaft. A sealhead is positioned proximate or near the negative air chamber, which has outer and inner walls forming a hollow chamber between them. The sealhead also includes a topout plate with at least one opening communicating with the hollow chamber. This configuration increases the volume of the negative air chamber, thereby improving suspension performance.

In some embodiments, the topout plate can be threadedly attached to the sealhead body. The topout plate is configured to contact a topout bumper or other contact body positioned along the shaft. The sealhead may also have a base portion with a larger diameter than an extended portion, both featuring an aperture configured to receive and retain the shaft. The outer wall of the sealhead may include annular grooves with air seals positioned therein to prevent air travel between chambers. The outer wall of the sealhead further comprises an anti-click seal configured to prevent noises. The sealhead thus provides improved suspension characteristics and adjustability for various riding conditions.

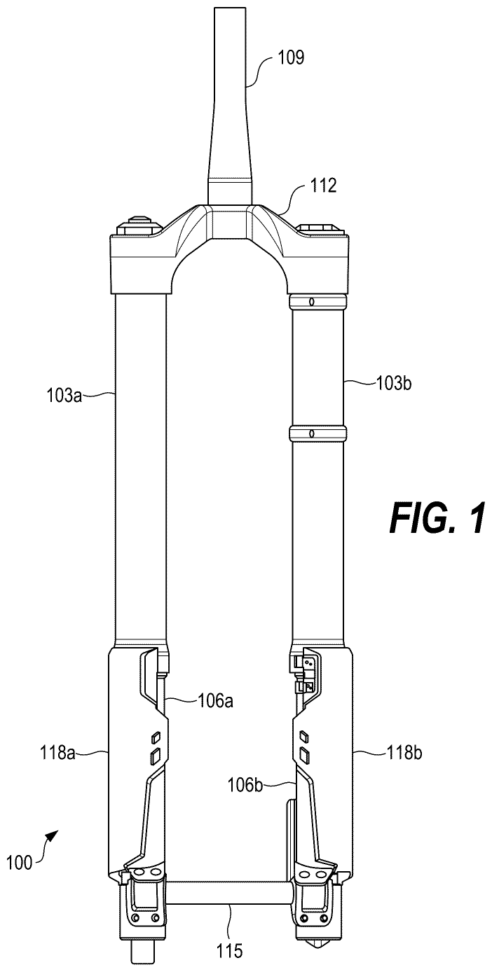

Turning now to the figures, FIGS. 1, 2, and 3 show front views of a suspension system according to various embodiments. The suspension system includes a suspension fork 100. While an inverted-type of suspension fork 100 is shown and described in various embodiments, it is understood that the components and functions described herein can also be implemented with other types of suspension forks (e.g., non-inverted suspension forks) and suspension systems without deviating from the principles of the disclosure.

Referring among FIGS. 1-3, the suspension fork 100 includes upper tubes 103a, 103b (collectively “upper tubes 103”) and lower tubes 106a, 106b (collectively “lower tubes 106”). A first lower tube 106a is slidably engaged with a first upper tube 103a, and a second lower tube 106b is slidably engaged with a second upper tube 103b, as can be appreciated. To this end, the upper tubes 103 can have a diameter larger than a diameter of the lower tubes 106 in some implementations.

The slidable engagement between the upper tubes 103 and lower tubes 106 allows for compression and extension of the suspension fork 100 as a rider traverses various terrain on a bicycle or similar vehicle. When the rider encounters bumps, obstacles, or uneven surfaces, the lower tubes 106 may telescope into the upper tubes 103, absorbing shock and vibration. This movement helps to maintain tire contact with the ground, improving traction and control. As the suspension fork 100 rebounds after compression, the lower tubes 106 extend back out from the upper tubes 103, preparing the suspension for the next impact. The sliding action between the upper tubes 103 and the lower tubes 106 may be facilitated by bushings, seals, and bath oil, which work together to reduce friction and ensure consistent performance throughout the travel range of the suspension fork 100.

The suspension fork 100 further includes a steerer tube 109, a crown 112, and a through-axle 115. The crown 112 can couple the upper tubes 103 to one another, and the through-axle 115 can couple the lower tubes 106 to one another. The steerer tube 109 and the crown 112 can collectively form a crown-steerer assembly, and the steerer tube 109 can extend vertically from a central portion of the crown 112. The upper tubes 103 can be assembled by press-fit or pinch-bolts to the crown-steerer assembly in some implementations.

The suspension fork 100 can be fastened to the headtube of a bicycle, motorcycle, or other two-or three-wheeled vehicle through a set of headset bearings internal to the steerer tube 109 and steered by a bolt-on stem-handlebar assembly. This configuration can provide a secure connection between the suspension fork 100 and a frame of a vehicle while allowing for smooth steering control.

The through-axle 115 can be used to further secure the suspension fork 100 to a vehicle. For example, the through-axle 115 can be passed through a hub of a wheel of a vehicle including, but not limited to, a front wheel of a bicycle or motorcycle. Left tubes 103a, 106a can be positioned on a first side of the wheel, and right tubes 103b, 106b can be positioned on a second, opposing side of the wheel, as can be appreciated.

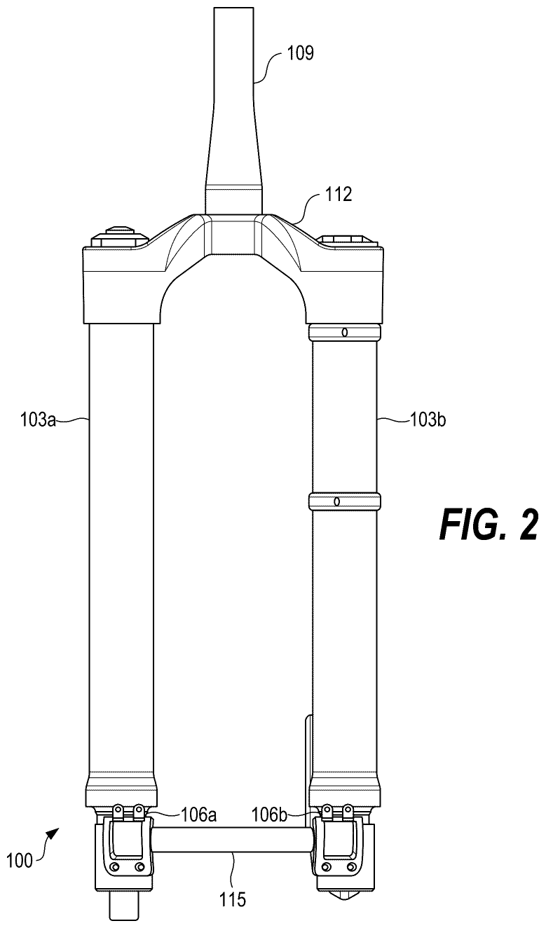

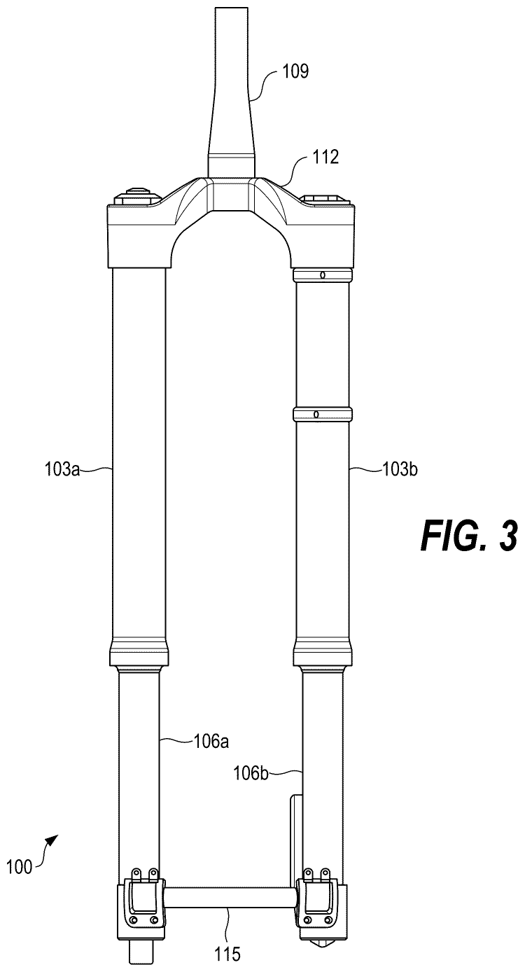

In FIG. 1, the suspension fork 100 includes lower guards 118a, 118b (collectively “lower guards 118”) that cover the lower tubes 106, protecting the lower tubes 106 from debris, impact, and other degrading forces. The lower guards 118 are omitted from view in FIGS. 2 and 3 for explanatory purposes, however. The lower guards 118 can be detachably attachable to the suspension fork 100 in some embodiments, or can be integral with the upper tubes 103.

The steerer tube 109, crown 112, upper tubes 103, and lower tubes 106 of the suspension fork 100 can be constructed from a variety of materials selected to provide an optimal balance of strength, weight, and performance characteristics. In some implementations, these components, among other components of the suspension fork 100, can be fabricated from high-strength aluminum alloys, which offer desirable stiffness-to-weight ratios and corrosion resistance. Carbon fiber composites can also be utilized, particularly for the steerer tube 109, crown 112, and upper tubes 103, to further reduce weight while maintaining structural integrity. In other cases, the lower tubes 106 can be constructed from steel alloys to enhance durability and withstand the stresses of repeated compression and extension cycles. Titanium alloys may be employed in premium fork designs, offering a combination of low weight, high strength, and vibration damping. The choice of materials for each component can be selected to meet specific performance requirements, rider preferences, and intended use cases of the suspension fork 100.

FIG. 2 shows the suspension fork 100 in full compression representing the maximum travel of the suspension fork 100, where the lower tubes 106 have telescoped fully into the upper tubes 103. During full compression, an air-spring assembly, as will be described, is at its maximum pressure, providing the greatest resistance to further compression. Bottom-out bumpers positioned in topcaps attached to the upper tubes 103, if present, are contacted by lower tubes 106 or other component to prevent metal-to-metal contact between the lower tubes 106 and topcaps attached to the upper tubes 103, as can be appreciated. FIG. 2 illustrates an extreme end of the travel range of the suspension fork 100, which typically occurs during significant impacts or landings from large drops.

FIG. 3, on the other hand, shows the suspension fork 100 in full extension or rebound. In this position, the lower tubes 106 are extended to their maximum length from the upper tubes 103, representing an opposite end of the travel range from the full compression shown in FIG. 2. This often occurs when the vehicle is unloaded or when the suspension is rebounding after absorbing an impact. The difference between the full extension position shown in FIG. 3 and the full compression position shown in FIG. 2 together illustrate a maximum available travel of the suspension fork 100.

In the fully extended position, an air-spring assembly, as will be described, positioned in upper tubes 103 or lower tubes 106 may be at its lowest pressure state. This configuration may allow for maximum sensitivity to small bumps and vibrations at the beginning of travel of the suspension fork 100. The relationship between the upper tubes 103 and lower tubes 106 in this position may also affect initial stiffness and responsiveness of the suspension fork 100.

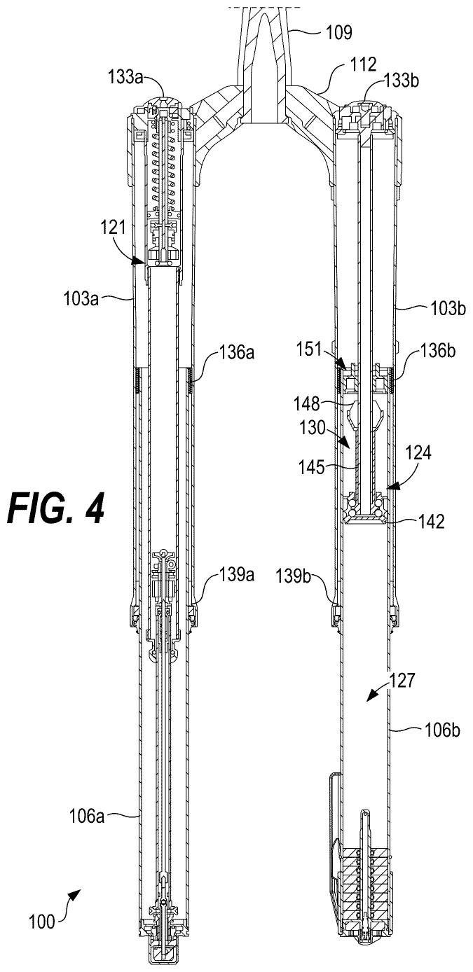

Turning now to FIG. 4, FIG. 4 shows a cross-sectional view of the suspension fork 100 depicting various internal components. Specifically, FIG. 4 shows the suspension fork 100 in a fully extended state similar to that of FIG. 3. Referring to FIG. 4, the suspension fork 100 can include a damper assembly 121 positioned in the first upper tube 103a and/or the first lower tube 106a, and an air-spring assembly 124 positioned in the second upper tube 103b and/or the second lower tube 106b. In other words, the suspension fork 100 can include a damper assembly 121 positioned in tubes 103a, 106a on a first side (e.g., a left side) of the suspension fork 100, and an air-spring assembly 124 positioned in the tubes 103b, 106b on a second side (e.g., a right side) of the suspension fork 100.

This configuration illustrates a dual-chamber damper and air-spring assembly that can be provided in high-performance inverted suspension forks 100. The damper assembly 121 can be configured to control a rate of compression and rebound of the suspension fork 100 and provide adjustable damping characteristics to suit various riding conditions and preferences. The damper assembly 121 can include, for example, an upper piston, a lower piston, shim stacks, and oil to create hydraulic resistance.

On the other hand, the air-spring assembly 124 is configured to provide a main spring force of the suspension fork 100. The air-spring assembly 124 utilizes compressed air to resist compression and return the suspension fork 100 to its extended position, shown in FIG. 3.

Referring again to FIG. 4, the air-spring assembly 124 includes a positive air chamber 127 and a negative air chamber 130 positioned within inner walls of a cylinder defined by inner walls of the upper tubes 103b and/or the lower tube 106b. While a cylinder-shape is described, it is understood that other shapes of chambers can be employed. The positive air chamber 127 and the negative air chamber 130 can be adjusted to fine-tune behavior of the suspension fork 100 throughout its travel range, as will be described.

The suspension fork 100 can include one or more compression adjusters 133a. For instance, a first compression adjuster 133a, positioned on the crown 112 above the first upper tube 103a, can be used to adjust or control desired characteristics of the damper assembly 121.

The compression adjuster 133a may provide an interface for riders or vehicle operators to fine-tune the suspension characteristics of the suspension fork 100. In some implementations, each compression adjuster 133a may feature a rotatable dial or knob that an operator can manipulate to adjust various suspension parameters. By rotating the dial clockwise or counterclockwise, the operator may increase or decrease compression damping, respectively.

For the first compression adjuster 133a associated with the damper assembly 121, the operator may adjust the compression damping to control how quickly the suspension fork 100 compresses under load. A firmer setting achieved by rotating the dial clockwise, for example, may provide more resistance to compression, which can be beneficial for smoother terrain or when the rider desires a more responsive feel. Conversely, a softer setting achieved by rotating the dial counterclockwise, for example, may allow for easier compression, improving small bump sensitivity and traction on rough terrain.

In some embodiments, the compression adjuster 133a includes detents or click positions, providing tactile feedback to the operator and allowing for more precise and repeatable adjustments. Additionally, the compression adjuster 133a may include visual indicators, such as numbered markings or color-coded zones, which may help riders track and replicate their preferred settings across different riding conditions.

The air-spring assembly 124 can include an air piston 142 (or piston 142) attached to a shaft 145. The air piston 142 can have an outer diameter that closely conforms to an inner diameter of the cylinder or chambers 127, 130. As such, the air piston 142 can be described as dividing the cylinder into the negative air chamber 130 and the positive air chamber 127. The shaft 145 translates within the upper tube 103b and/or the lower tube 106b which, in turn, translates movement of the air piston 142.

The negative air chamber 130 and the positive air chamber 127 work in conjunction to provide a balanced and responsive suspension action. The negative air chamber 130 can help to reduce initial breakaway force required to initiate suspension movement, improving small bump sensitivity and providing a desirable feel at the beginning of the travel. As the suspension fork 100 compresses, the positive air chamber 127 can provide increasing resistance, helping to support the operator's weight and prevent bottoming out on larger impacts. The relative volumes and pressures of these chambers can be adjustable, allowing riders to fine-tune the behavior of the suspension fork 100 to suit preferences and riding conditions.

The damper assembly 121 and/or the air-spring assembly 124 can include various bushings, such as upper bushings 136a, 136b (collectively “upper bushings 136”), lower bushing 139a, 139b (collectively “lower bushings 139”), and so forth. The upper bushings 136 can be positioned near a top of the lower tubes 106, while the lower bushings 139 can be positioned near the bottom of the upper tubes 103. Together, these bushings 136, 139 can define the travel range of the upper tubes 103 and the lower tubes 106, while reducing friction and ensuring proper alignment throughout the travel range of the suspension fork 100.

The bushings 136, 139 can be made from low-friction materials such as polytetrafluoroethylene (PTFE) or other polymers capable of withstanding the dynamic loads and environmental conditions experienced by the suspension fork 100. The bushings 139, 139 can distribute forces evenly across the sliding surfaces, preventing metal-to-metal contact between the upper tubes 103 and the lower tubes 106, which can reduce wear and extends the life of the suspension fork 100 while also contributing to a smooth and more responsive suspension action.

The air piston 142 can translate or otherwise move within the cylinder in response to compression and extension of the suspension fork 100. In some implementations, the hollow air shaft 145 extends from the air piston 142 towards the upper portion of the suspension fork 100, passing through the negative air chamber 130. This can facilitate air transfer between chambers during fork travel, providing spring-like characteristics.

The shaft 145 includes the air piston 142 positioned at a bottom distal end of the shaft 145. A topout bumper 148 can be positioned at another location along the shaft 145. The topout bumper 148 can be fixedly attached to the shaft 145 such that, during operation, the topout bumper 148 contacts at least a portion of the sealhead assembly 151 to define a travel range of the shaft 145 and the air piston 142, as will be described. The topout bumper 148 may be formed from various materials such as rubber, elastomers, or other resilient polymers that can absorb impact and provide cushioning when the suspension fork reaches full extension.

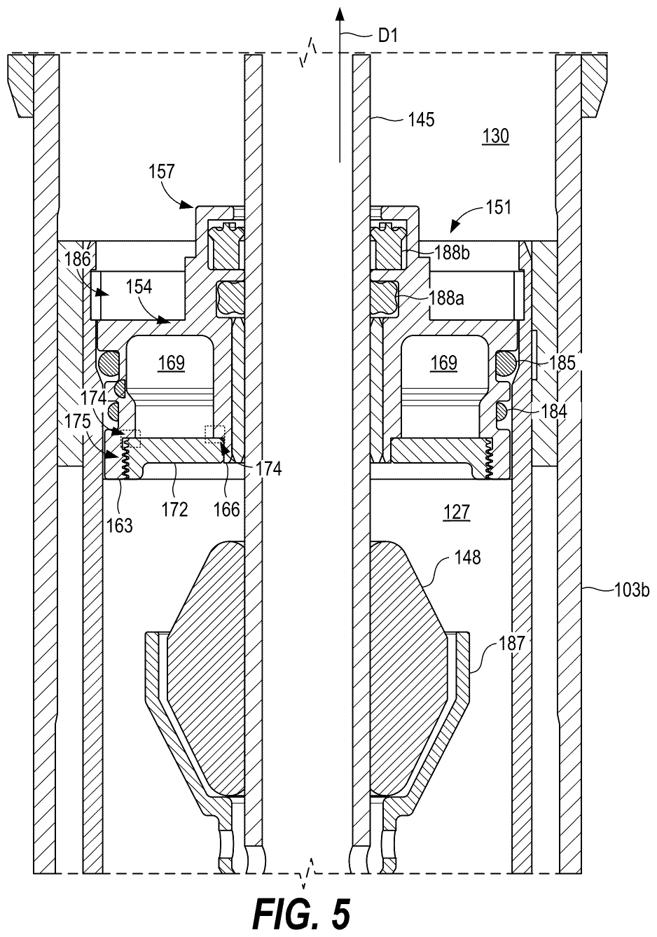

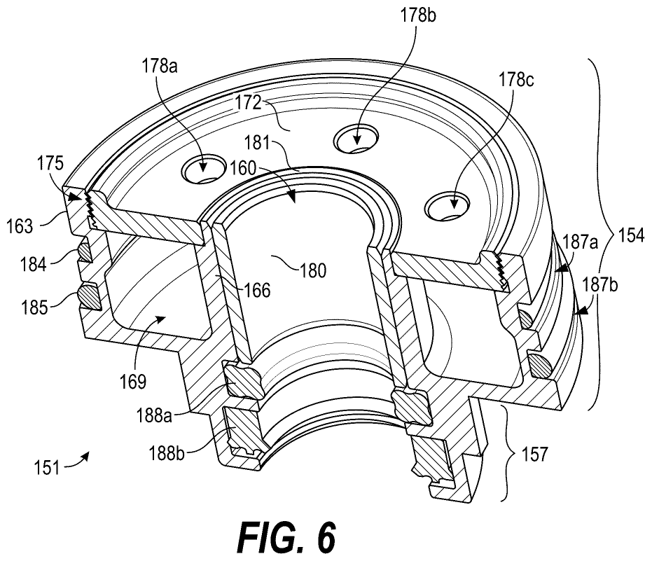

Turning now to FIGS. 5 and 6, FIG. 5 shows an enlarged cross-sectional view of the shaft 145, the topout bumper 148, and the sealhead assembly 151, among other components. FIG. 6 shows a bottom perspective, cross-sectional view of the sealhead 151 according to various embodiments.

Referring collectively to FIGS. 5 and 6, the shaft 145 pulls outward along direction D1 during negative travel to move the air piston 142 (FIG. 4), such as a distance of approximately 10 mm although other distances are envisioned. The topout bumper 148 will contact at least a portion of the sealhead assembly 151 to limit movement of the shaft 145 and air piston 142.

The sealhead assembly 151 has a sealhead body that includes a base portion 154 and an extended portion 157. The extended portion 157 can extend from the base portion 154 as a neck. To this end, the base portion 154 has a diameter greater than the extended portion 157. An aperture 160 extends through the base portion 154 and the extended portion 157, as will be described. The base portion 154 and the extended portion 157 can both be annular or, in other words, the base portion 154 and the extended portion 157 can both have a circular-or oval-shaped cross-section.

At least the base portion 154 of the sealhead body includes an outer wall 163 and an inner wall 166. As the base portion 154 can be annular, at least a portion of the outer wall 163 and the inner wall 166 can be annular and can be positioned substantially parallel to one another. The inner wall 166 can define the aperture 160 in which the shaft 145 is movably received. For instance, the shaft 145 can translate, displace, or otherwise move in the aperture 160 along a longitudinal axis (e.g., upwards and downwards in FIGS. 5 and 6). The position of the sealhead 151 remains substantially fixed despite translation of the shaft 145.

The outer wall 163 and the inner wall 166 can collectively define a chamber 169 positioned between the outer wall 163 and the inner wall 166, which is hollow. A top of the chamber 169 is defined by a topout plate 172, which extends between the outer wall 163 and the inner wall 166. The topout plate 172 can include an annular-shaped disc that is attached to one or both of the outer wall 163 and the inner wall 166. In some embodiments, a threaded interface 175 is provided having corresponding threads between the topout plate 172 and the outer wall 163. The threaded interface 175 between the topout plate 172 and the body of the sealhead can eliminate rattling of the components in rough terrain. It is understood, however, that other types of connections can be employed to attach the topout plate 172 to one or both of the outer wall 163 and the inner wall 166. In some embodiments, the outer wall 163 and the inner wall 166 can comprise plate stopping surfaces 174 to prevent the topout plate 172 from protruding into the hollow chamber 169 upon contact with the topout bumper 148. In some embodiments, the topout plate 172 can be integral with one or both of the outer wall 163 and the inner wall 166.

The topout plate 172 includes one or more openings 178a . . . 178c (collectively “openings 178” or “communication openings 178”) positioned therethrough. The openings 178 are in communication with the chamber 169, such that air can pass through the openings 178 into the hollow chamber 169 and vice-versa. In some embodiments, the openings 178 can be positioned radially outward from the aperture 160 defined by the inner wall 166. The openings 178 as shown can each be circular-shaped or ovular-shaped. However, it is understood that other shapes of the openings 178 can be employed. By virtue of the chamber 169 being hollow and in communication with the openings 178, and the sealhead 151 being proximate (e.g., in or close to) the negative air chamber 130, a volume of the negative air chamber 130 is increased.

The topout bumper 148 may contact the topout plate 172 of the sealhead assembly 151 when the suspension fork 100 reaches full extension, limiting the upward travel of the air piston 142 and shaft 145. The contact between the topout bumper 148 and the topout plate 172 can define a maximum travel point of the suspension fork 100, preventing over-extension and providing a smooth transition as the suspension fork 100 returns to its fully extended position.

In some embodiments, the sealhead assembly 151 can include an end surface 181 of the inner wall 166 of the sealhead body which may contact the topout bumper 148. In some embodiments, the end surface 181 is sized and positioned to contact the topout bumper 148 positioned on the shaft 145 and further reduce stresses imposed during the contact. In some embodiments, the topout bumper 148 is configured to contact the top out plate 172 at any portion of the topout plate 172 inboard of the openings 178 formed in the top out plate 172, or at any other desired portion of the topout plate 172, sealhead body, or a bushing 180 inboard of the openings 178. In some embodiments, the topout bumper 148 is configured to contact at least a portion of the sealhead assembly 151 located between the openings 178 formed in the top out plate 172 and the aperture 160. Said at least a portion of the sealhead assembly 151 located between the openings 178 formed in the top out plate 172 and the aperture 160 may include a portion of the top out plate 172, and/or the end surface 181 of the inner wall 166, and/or a bushing 180.

The sealhead assembly 151 may include a multitude of seals to maintain pressures in the negative air chamber 130 and the positive air chamber 127. For instance, in some embodiments, multiple annular seals 184 can be positioned at various locations to enhance sealing and prevent air or oil leakage. In some implementations, an annular seals 184 can be positioned in an annular groove 187a (or external annular groove), on the outer surface of the base portion 154. This seal 184a may create a seal between the outer wall 163 of the sealhead body and the inner surface of the cylinder or tube in which the sealhead assembly 151 is installed. The annular seals 184 may be made from materials such as rubber, silicone, or other elastomers that can maintain their sealing properties under dynamic conditions and varying pressures encountered during operation of the suspension fork 100.

In some embodiments, the sealhead assembly 151 may comprise an anti-click device 185 (such as a rubber preload ring, or the like). The sealhead assembly 151 can move up and down axially and hit a retaining ring 186, when the sealhead assembly 151 does not have the anti-click device 185. The anti-click device 185 preloads the sealhead assembly 151 upward against the retaining ring 186 thereby preventing undesirable clicking noises and movement of the sealhead assembly 151. Additionally, first and second annular dynamic air shaft seals 188a, 188b may be positioned within the aperture 160 in the extended portion 157 of the sealhead 151. The third and fourth dynamic air shaft seals 188a, 188b can provide a seal around the shaft 145 as it moves through the aperture 160, helping to maintain separation between the negative air chamber 130 and the ambient air pressure in the interior of the upper tube 103b which has some oil for oil bath lubrication. The third and fourth dynamic air shaft seals 188a, 188b may be configured to minimize friction while maintaining an effective seal, potentially incorporating low-friction coatings, additives, or materials. In some cases, additional seals may be incorporated at other locations on the sealhead assembly 151 to further enhance sealing performance or to provide redundancy in critical areas.

The inner surface of the aperture 160, as defined by the inner wall 166 of the sealhead body, may be generally uniform to accommodate the shaft 145. The uniform surface can provide consistent contact and support for the shaft 145 as it moves through the aperture 160. In some aspects, the inner surface may be precision-machined or polished to reduce friction and wear on both the shaft 145 and the inner wall 166. The uniformity of the inner surface can also contribute to maintaining proper alignment of the shaft 145 during its travel, which can help ensure smooth operation of the air-spring assembly. In some embodiments, a bushing 180 is provided in the aperture 160.

In some cases, the inner surface of the aperture 160 may be coated with a low-friction material or treated to enhance its durability and performance characteristics. The diameter of the aperture 160 may be closely matched to the outer diameter of the shaft 145, with sufficient clearance to allow for smooth movement while minimizing air leakage between chambers 127, 130.

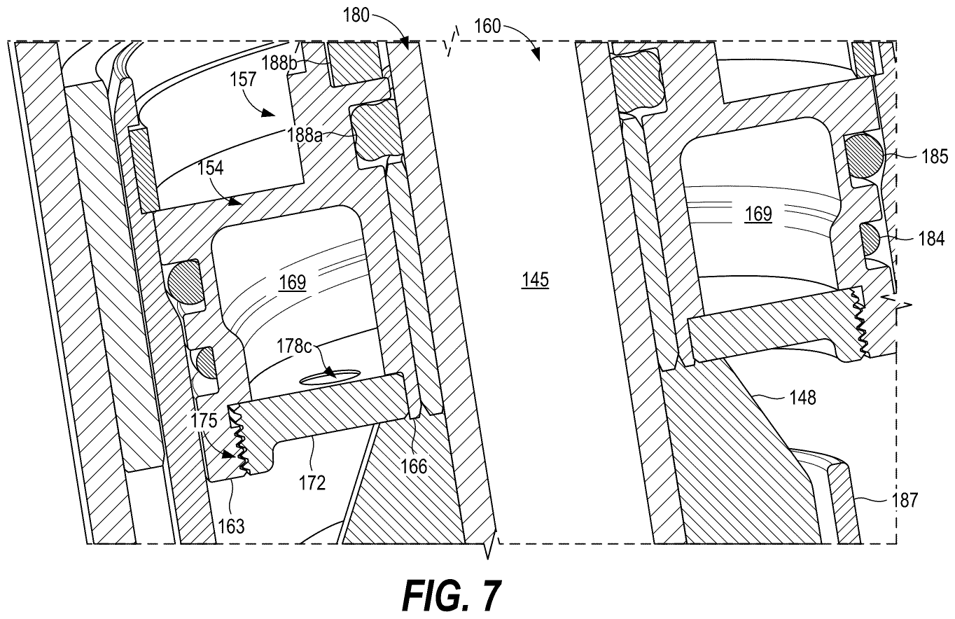

Moving along, FIG. 7 illustrates a cross-sectional view of a portion of the air-spring assembly 124, showing the interaction between the sealhead assembly 151 and the shaft 145. Specifically, the topout bumper 148 is shown contacting at least a portion of the topout plate 172 in FIG. 7. The shaft 145 extends through the center of the air-spring assembly 124, with the topout bumper 148 mounted thereon via a topout bumper mount 187 that couples the topout bumper 148 to the shaft 145. The shaft 145 provides controlled movement of the topout bumper 148 and the air piston 142 relative to the sealhead assembly 151.

The hollow chamber 169 within the sealhead assembly 151 is shown in FIG. 7, increasing the negative air volume in the negative air chamber 130. The increased volume may contribute to improved small bump sensitivity and overall suspension performance of the suspension fork 100, as can be appreciated. The third opening 178c is shown in the sectional view, demonstrating openings 178 positioned radially outward from the aperture 160 defined by the inner wall 166 of the sealhead body.

The openings 178 may be arranged in various configurations on the topout plate 172 to optimize air flow and suspension performance. In some aspects, the openings 178 may be evenly distributed around the circumference of the topout plate 172, while in other implementations, the openings 178 may be clustered in specific areas, such as an area proximate the topout bumper 148. The number of openings 178 may vary depending on the desired air flow characteristics and overall design of the air-spring assembly 124. While various embodiments shown annular-or circular-shaped openings 178, alternatives to circular or ovular designs may include rectangular, triangular, or polygonal openings. In some cases, the openings 178 may feature tapered or chamfered edges to influence air flow dynamics. The size and shape of the openings 178 may be customized to fine-tune the behavior of the air-spring assembly 124, incorporating asymmetrical designs or variable sizing among the openings 178 to achieve specific performance characteristics.

The threaded interface 175 between the topout plate 172 and the sealhead 151 is shown in FIG. 7. This connection method may allow for easy assembly and disassembly of the components, facilitating manufacturing, maintenance, or customization of the suspension fork 100. The threaded interface 175 may also provide a secure connection that can withstand the dynamic forces experienced during the operation of the suspension fork 100. Although, the threaded coupling is show in in FIG. 7, in some embodiments, the topout plate can be coupled to the sealhead body 151 by other mechanism, such as, but not limited to a wire ring or a retaining ring.

FIG. 7 further illustrates a stepped profile of the base portion 154 and the extended portion 157 of the sealhead 151, where the base portion 154 has a greater outer diameter than the extended portion 157. Such stepped interface can facilitate providing different sealing surfaces, accommodating various internal components, or optimizing the distribution of forces within the air-spring assembly 124.

In some embodiments, the sealhead assembly 151 may be positioned at an end of a tube 103 of the suspension fork 100 to seal the negative air chamber 130. In some aspects, the sealhead assembly 151 may create an airtight barrier between the negative air chamber 130 and other parts of the suspension fork 100. The topout plate 172 of the sealhead assembly 151, which includes open communication openings 178, may work in conjunction with the hollow chamber 169 beneath it to increase the negative air spring volume. This increased volume may result in a lower and more linear spring rate for the air spring assembly 124. The combination of the open openings 178 and the hollow chamber 169 may allow for a larger effective negative air chamber 130, which in some cases can contribute to improved small bump sensitivity and a more supple initial stroke of the suspension fork 100. The sealhead assembly 151 may thus provide a way to optimize air spring characteristics without necessarily increasing the overall size of the suspension fork 100.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A suspension fork, comprising:
a first tube;
a second tube telescopically engaged with the first tube;
an air-spring assembly disposed within at least one of the first tube or the second tube, the air-spring assembly comprising:
a positive air chamber and a negative air chamber;
a piston dividing the positive air chamber and the negative air chamber, the piston coupled to and driven by a shaft; and
a sealhead assembly positioned proximate the negative air chamber, the sealhead assembly comprising:
a sealhead body comprising an outer wall and an inner wall, the inner wall defining an aperture in which the shaft is movably received;
a hollow chamber positioned between the outer wall and the inner wall; and
a topout plate comprising at least one opening in communication with the hollow chamber.

2. The suspension fork according to claim 1, wherein the topout plate is coupled to the sealhead body.

3. The suspension fork according to claim 1, further comprising a topout bumper configured to contact at least a portion of the sealhead assembly.

4. The suspension fork according to claim 3, wherein the at least one opening is positioned radially outward from the aperture defined by the inner wall.

5. The suspension fork according to claim 4, wherein the outer wall and the inner wall further comprise plate stopping surfaces.

6. The suspension fork according to claim 1, wherein the hollow chamber of the sealhead assembly increases a volume of the negative air chamber.

7. The suspension fork according to claim 1, wherein the sealhead body comprises a base portion and an extended portion extending from the base portion, the base portion having a diameter greater than the extended portion, wherein the aperture extends through the base portion and the extended portion.

8. An air-spring assembly configured to be disposed within at least one of a lower tube or an upper tube of a suspension fork, the air-spring assembly comprising:
a shaft comprising a first end and a second end opposite the first end,
a piston attached to the shaft at a first end, and a topout bumper attached along the shaft, the piston configured to translate within a cylinder defined by the at least one of the lower tube or the upper tube, the piston defining a positive air chamber and a negative air chamber; and
a sealhead assembly positioned proximate the negative air chamber, the sealhead assembly comprising:
a sealhead body comprising an outer wall and an inner wall, the inner wall defining an aperture in which the shaft is movably received;
a chamber positioned between the outer wall and the inner wall in communication with the negative air chamber such that a volume of the negative air chamber is increased; and
a topout plate comprising at least one opening in communication with the chamber.

9. The air-spring assembly according to claim 8, wherein the topout plate is coupled to the sealhead body.

10. The air-spring assembly according to claim 8, wherein the outer wall and the inner wall of the sealhead body further comprise plate stopping surfaces.

11. The air-spring assembly according to claim 8, wherein the topout bumper is configured to contact at least a portion of the sealhead assembly.

12. The air-spring assembly according to claim 8, wherein the suspension fork is an inverted suspension fork.

13. The air-spring assembly according to claim 8, wherein the sealhead assembly further comprises an anti-click device positioned between the outer wall of the sealhead body and an inner wall of the cylinder.

14. The air-spring assembly according to claim 8, wherein the at least one opening is positioned radially outward from the aperture defined by the inner wall.

15. The air-spring assembly according to claim 8, wherein the sealhead body comprises a base portion and an extended portion extending from the base portion, the base portion having a diameter greater than the extended portion, wherein the aperture extends through the base portion and the extended portion.

16. The air-spring assembly according to claim 8, wherein the outer wall comprises an outer wall surface configured to contact an inner surface of the cylinder, the outer wall surface comprising at least one annular groove having at least one air seal positioned therein that prevents air to travel along the outer wall surface from the negative air chamber.

17. A sealhead assembly, comprising:
a sealhead body comprising an outer wall and an inner wall, the inner wall defining an aperture configured to receive an air piston shaft;
a hollow chamber positioned between the outer wall and the inner wall; and
a topout plate comprising at least one opening in communication with the hollow chamber.

18. The sealhead assembly according to claim 17, wherein the outer wall comprises an outer wall surface configured to contact an inner surface of a suspension fork tube, the outer wall surface comprising at least one annular groove having at least one air seal positioned therein that prevents air to travel along the outer wall surface from the negative air chamber.

19. The sealhead assembly according to claim 17, wherein the topout plate is coupled to the body portion, and the at least one opening is positioned radially outward from the aperture.

20. The sealhead assembly according to claim 17, further comprising a base portion and an extended portion extending from the base portion, the base portion having a diameter greater than the extended portion, wherein the aperture extends through the base portion and the extended portion.
